(19) United States
(12) Patent Application Publication
(10) Pub. No.: US 2008/0146287 A1
(43) Pub. Date: Jun. 19, 2008

(54) MOBILE PHONE WITH ANTI-MOSQUITO FUNCTION

(75) Inventors: Qiang Zhu, Shenzhen (CN); Xiao-Lin Gan, Shenzhen (CN); Yu-Kuang Ho, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/773,975

(22) Filed: Jul. 6, 2007

(30) Foreign Application Priority Data
Dec. 19, 2006 (CN) 200610201325.1

(51) Int. Cl. H04B 1/38

(52) U.S. Cl. 455/566

(57) ABSTRACT

A mobile phone with anti-mosquito function includes an anti-mosquito control module for receiving a control signal, a frequency generator being electrically connected to the anti-mosquito control module for generating a frequency signal in the range of at least one of a wing beat frequency of a male mosquito and a wing beat frequency of a dragonfly, a frequency select unit being electrically connected to the frequency generator for selecting one of the wing beat frequency of a male mosquito or the wing beat frequency of a dragonfly, an audio signal generator being electrically connected to the frequency select unit for converting the selected frequency signal into a sonic signal; and
a loudspeaker being electrically connected to the audio signal generator for emitting the sonic signal to repel female mosquitoes.

### BACKGROUND OF THE INVENTION

1. Field of the Invention

The present invention relates to mobile phones. In particular, the present invention relates to a mobile phone with anti-mosquito function.

2. Description of related art

A plurality of diseases, such as dengue fever, often break out because of mosquitoes bites. A conventional method for dissipating the mosquitoes is utilizing an anti-mosquito device, such as a mosquito-capture lamp or a chemical aerosol, to kill the mosquitoes. However, such anti-mosquito devices are not convenient to carry outdoors.

With the development of wireless communication, mobile phones are now in widespread use. Mobile phones enable consumers to enjoy the convenience of numerous high technology services anytime and anywhere. In addition to general communication functions, many mobile phones also provide extra functions such as Infrared Ray (IR) data transmission, Global Positioning System (GPS) access for security purposes, Internet linkage, games, etc. Worldwide, the number of consumers using mobile phones continues to grow. It is predicted that the mobile phone will become an indispensable personal accessory for almost everyone who can afford it, and that the available functions of a typical mobile phone will continue to multiply. Value of a mobile phone can be increase by the addition of an anti-mosquito function.

What is needed is a mobile phone with anti-mosquito function.

### SUMMARY OF THE INVENTION

An exemplary mobile phone with anti-mosquito function includes an anti-mosquito control module for receiving a control signal, a frequency generator being electrically connected to the anti-mosquito control module for generating a frequency signal in the range of at least one of a wing beat frequency of a male mosquito and a wing beat frequency of a dragonfly, a frequency select unit being electrically connected to the frequency generator for selecting one of the wing beat frequency of a male mosquito or the wing beat frequency of a dragonfly, an audio signal generator being electrically connected to the frequency select unit for converting the selected frequency signal into a sonic signal; and a loudspeaker being electrically connected to the audio signal generator for emitting the sonic signal to repel female mosquitoes.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a block diagram of a mobile phone with anti-mosquito function according to a preferred embodiment of the present invention; and

FIG. 2 is an isometric view of the mobile phone with anti-mosquito function according to FIG. 1.

### DETAILED DESCRIPTION OF THE INVENTION

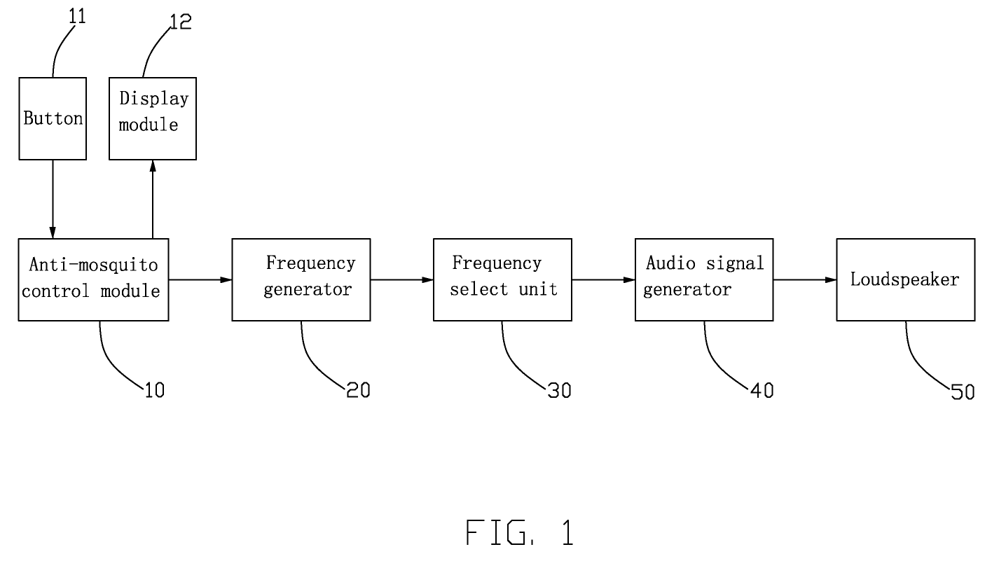

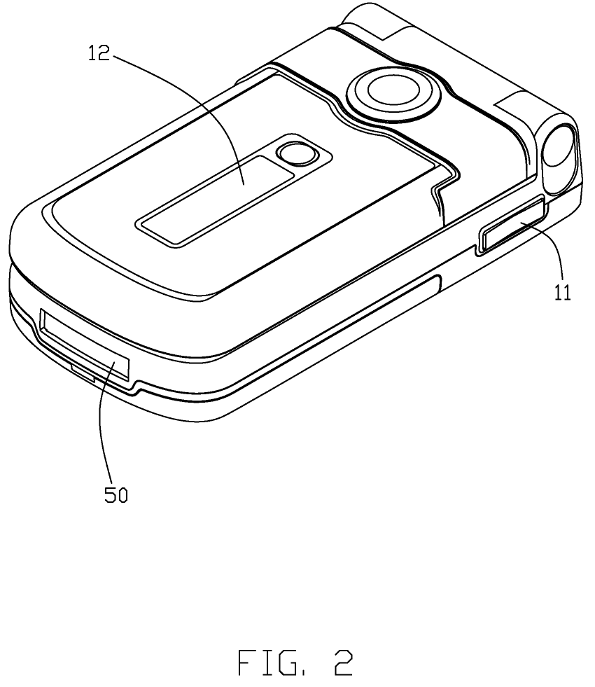

Referring to FIG. 1 and FIG. 2, a mobile phone with anti-mosquito function according to a embodiment of the present invention includes an anti-mosquito control module 10, a button 11, a display module 12, a frequency generator 20, a frequency select unit 30, an audio signal generator 40, and a loudspeaker 50.

The button 11 and the display module 12 are electrically connected to the anti-mosquito control module 10. The button 11 is a single button that need not be placed in a usual button area of the mobile phone, for example, the button 11 is set in a profile of the mobile phone. The display module 12 is a liquid crystal display (LCD) module, which is set on a shell of the mobile phone. The anti-mosquito control module 10 is a control chip of the mobile phone.

The anti-mosquito control module 10 is electrically connected to the frequency generator 20. In this embodiment, the frequency generator 20 is a radio frequency amplifier integrated in the mobile phone. The frequency generator 20 can be an a stable multivibrator or a quartz oscillator. The frequency generator 20 is electrically connected to the frequency select unit 30. The frequency select unit 30 is electrically connected to the audio signal generator 40, which is electrically connected to the loudspeaker 50. In this embodiment, the loudspeaker 50 is a buzzer in the mobile phone.

When the button 11 is pressed down, the button 11 generates a control signal for turning on an anti-mosquito function. The anti-mosquito control module 10 receives the control signal for controlling the frequency generator 20 to generate a frequency signal in the range of at least one of a wing beat frequency of a male mosquito and a wing beat frequency of a dragonfly. As we know, the male mosquitoes beat their wings 450 to 600 times per second, and the dragonfly beat its wings 20 to 30 times per second. In this embodiment, the frequency signal is from 22 to 30 HZ or 450 to 600 HZ. One of the wing beat frequency of a male mosquito or the wing beat frequency of a dragonfly is selected by the frequency select unit 30 to transmit to the audio signal generator 40.

The audio signal generator 40 converts the selected frequency signal into a sonic signal. The loudspeaker 50 emits the sonic signal. The sonic signal mimics the sounds of male mosquitoes and of dragonflies, which repel female mosquitoes. Normally, only the female mosquitoes bite and the male mosquitoes follows the exodus of the females, the problem of anti-mosquitoes has been solved by repelling the female mosquitoes with the sonic signal.

The anti-mosquito function can be shut off if the button 11 is pressed down again. The button 11 acts as a switch apparatus for switching of the anti-mosquito function.

In this embodiment, a user simply chooses a quick icon, which is set in a start-up menu of the mobile phone, and turns on the anti-mosquito function of the mobile phone.

When the anti-mosquito function of the mobile phone is turned on, a text message or some other indication, can be displayed on the display module 12.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile phone with anti-mosquito function, comprising:
an anti-mosquito control module for receiving a control signal to turn on the anti-mosquito function;
a frequency generator being electrically connected to the anti-mosquito control module for generating a frequency signal in the range of at least one of a wing beat frequency of a male mosquito and a wing beat frequency of a dragonfly;
a frequency select unit being electrically connected to the frequency generator for selecting one of the wing beat frequency of a male mosquito or the wing beat frequency of a dragonfly;
an audio signal generator being electrically connected to the frequency select unit for converting the selected frequency signal into a sonic signal; and
a loudspeaker being electrically connected to the audio signal generator for emitting the sonic signal to repel female mosquitoes.

2. The mobile phone as described in claim 1, wherein the frequency signal is from 20 to 30 HZ or 450 to 600 HZ.

3. The mobile phone as described in claim 1, wherein the anti-mosquito control module is a control chip of the mobile phone.

4. The mobile phone as described in claim 1, wherein the frequency generator is a radio frequency amplifier integrated in the mobile phone.

5. The mobile phone as described in claim 1, wherein the loudspeaker is a buzzer in the mobile phone.

6. The mobile phone as described in claim 1, further comprising a button placed on the mobile phone for generating the control signal.

7. The mobile phone as described in claim 1, further comprising a display module for displaying whether the anti-mosquito function is turned on or not.

8. A mobile phone with anti-mosquito function, comprising:
a switch apparatus set on the mobile phone for generating a control signal;
an anti-mosquito control module for receiving the control signal to turn on the anti-mosquito function;
a frequency generator being electrically connected to the anti-mosquito control module for generating a frequency signal in the range of at least one of a wing beat frequency of a male mosquito and a wing beat frequency of a dragonfly;
a frequency select unit being electrically connected to the frequency generator for selecting one of the wing beat frequency of a male mosquito or the wing beat frequency of a dragonfly;
an audio signal generator being electrically connected to the frequency select unit for converting the selected frequency signal into a sonic signal; and
a loudspeaker being electrically connected to the audio signal generator for emitting the sonic signal to repel female mosquitoes.

9. The mobile phone as described in claim 8, wherein the frequency signal is from 20 to 30 HZ or 450 to 600 HZ.

10. The mobile phone as described in claim 8, wherein the anti-mosquito control module is a control chip of the mobile phone.

11. The mobile phone as described in claim 8, wherein the frequency generator is a radio frequency amplifier integrated in the mobile phone.

12. The mobile phone as described in claim 8, wherein the loudspeaker is a buzzer in the mobile phone.

13. The mobile phone as described in claim 8, wherein the switch apparatus is a button placed on the mobile phone.

14. The mobile phone as described in claim 8, further comprises a display module for displaying whether the anti-mosquito function is turned on or not.
